(19) United States
(12) Patent Application Publication
(10) Pub. No.: US 2026/0310911 A1
(43) Pub. Date: Oct. 8, 2026

(54) METHOD FOR DETECTING AN IN PARTICULAR POSITIONALLY VARIABLE RFID TAG

(71) Applicants: VUSIONGROUP GMBH, Fernitz-Mellach (AT); VusionGroup SA, Nanterre (FR)

(72) Inventors: Andreas RÖSSL, Fernitz-Mellach (AT); Horst KAUTSCHITZ, Fernitz-Mellach (AT); Philippe BOTTINE, Fernitz-Mellach (AT); Tarik FILALI ANSARY, Nanterre (FR)

(73) Assignees: VUSIONGROUP GMBH, Fernitz-Mellach (AT); VusionGroup SA, Nanterre (FR)

(21) Appl. No.: 19/479,912

(22) PCT Filed: May 31, 2023
(86) PCT No.: PCT/EP2023/064622

§ 371 Date: Oct. 29, 2025

(51) Int. Cl. G06K 7/10

(52) U.S. Cl. CPC G06K 7/10297

(57) ABSTRACT

Method for detecting a radio tag, in particular one that is variable in location, by means of detection devices positioned at different locations, wherein the method comprises the following method steps:

automatically selecting a number of detection devices that is smaller than the total number of detection devices for receiving a tag radio signal emitted by the radio tag and/or a product identification derived from the tag radio signal, wherein as a first criterion for automatic selection it is applied that, in relation to an in particular automatically determined device position of a device located at least temporarily in the vicinity of the radio tag, at least one of the detection devices is positioned favorably with respect to at least one other detection device for receiving the tag radio signal and/or the product identification.

### TECHNICAL FIELD

The invention relates to a method for detecting a radio tag, in particular one that is variable in location.

### BACKGROUND

Attempts to electronically detect radio tags which, for example, are attached to a product or its packaging efficiently in a large area have proven difficult.

Such radio tags can be realized, for example, as radio frequency identification tags, or RFID tags for short. Detecting them requires a mobile detection device, often referred to as a mobile reader, which must be carried to one of the RFID tags and brought into close contact with the RFID tag in order to detect it individually electronically. The use of stationary detection devices (stationary RFID readers), such as those installed in the entrance or exit areas of stores, also requires that the RFID tags be present locally, i.e. that the RFID tags be carried to the reader or moved past it in order to be detected electronically. Detection of the RFID tag therefore always requires proximity to it. In addition, the stationary RFID readers mentioned above must be in permanent operation, i.e. consume electrical power, so that individual RFID tags passing by them are not missed during detection.

Such radio tags can also be designed as Bluetooth radio tags, or BT radio tags for short. However, since their transmission power is typically very limited due to their miniaturized design, often very many Bluetooth-compliant stationary detection devices have to be installed for comprehensive detection in a large area, which essentially also have to be operated in continuous power-consuming mode in order to reliably detect the radio tags moving within their total coverage area.

The invention has therefore set itself the task of providing a method for detecting a radio tag so that the aforementioned problems are avoided.

### SUMMARY OF THE INVENTION

This task is solved by a method for detecting a radiotag, in particular one that is variable in location, by means of detection devices positioned at different locations, wherein the method comprises the following method steps, namely, automatically selecting a number of detection devices that is smaller than the total number of detection devices for receiving a tag radio signal emitted by the radio tag and/or a product identification derived from the tag radio signal, wherein as a first criterion for automatic selection it is applied that, in relation to an in particular automatically determined device position of a device located at least temporarily in the vicinity of the radio tag, at least one of the detection devices is positioned favorably with respect to at least one other detection device for receiving the tag radio signal and/or the product identification.

The measures according to the invention have the advantage that not all of the detection devices installed in a large area need to be involved in detecting the radio tag at the same time, but only a selection from the total number of installed detection devices, which are characterized by being favorably positioned for receiving the tag radio signal. This means that detection devices that are positioned too far away or that are less suitable or unsuitable for receiving the tag radio signal due to the topology or structure of the area are not involved and can therefore be used for other activities or operated in an energy-saving mode or deactivated altogether. Over time, however, the selection may change because, for example, the movement of the device means that other detection devices fulfil the first criterion and are therefore classified as favorably positioned. If this measure is used in an area that is very large in comparison to the transmission range of the radio tags and if very many detection devices are installed throughout the area, it can always be assumed that, with regard to a single device position, a very large number of detection devices do not fulfil the first criterion and are therefore not selected for the detection of the radio tags. This results in massive energy savings across all detection devices, because only a small proportion of the total number of detection devices are involved in detecting the radio tag, and sometimes only a single detection device is involved.

This selection process of detection devices thus forms the basis for energy-saving operation of the detection devices as a whole and also of each individual detection device, thereby making a significant contribution to the energy-saving operation of a system to which the detection devices belong. Incidentally, the method can be used not only with stationary radio tags, as is the case, for example, when such radio tags are attached to products that are stored on a shelf or resting on a parked load transport vehicle. Rather, the method can also be used with radio tags that are variable in location, as is the case when a product to which the radio tag is attached is moved, e.g. by a customer or an employee of a company. The same applies mutatis mutandis when a group of radio tags is moved together. In the case of a moving radio tag, it is to be expected that the selection of detection devices involved in the detection will change over time in accordance with the changing position of the device.

Further particularly advantageous embodiments and further developments of the invention are apparent from the dependent claims and the following description.

The invention is primarily used in retail and is therefore discussed in detail with reference to retail. However, the use of the invention is not limited to retail. Rather, it can also be used in industrial environments, such as in manufacturing or logistics. In all these areas of use, there is a fundamental need to transport goods or products, regardless of whether they are packaged individually or in groups, from one location to another, and in doing so, the products themselves or the packaging units in which they are packaged must be identified and/or the number of products or packaging units must be recorded. Since these product transports are not an end in themselves, but rather individual products or packaging units of these products must be deposited at specific locations along the movement path, and, if necessary, products or their packaging units must be taken over for further transport, there is also a need in this context to know the exact and consistent number of products or their packaging units being transported.

Against this background, it is also understandable that the area to be equipped with the detection devices often covers thousands or even tens of thousands of square meters and that good coverage for the accurate detection of the radio tags moving there also requires a relatively high total number of detection devices distributed throughout the area. Depending on the specific application scenario and the radio technology challenges involved, the total number of detection devices can therefore be assumed to be in the thousands or tens of thousands.

In retail, such as in a supermarket, electronic display devices are used that are attached, for example, to shelves or their shelf rails or directly to the products or their packaging. In such an application scenario, the electronic display devices are usually referred to as electronic shelf labels, or ESLs for short. They are primarily used to display product and/or price information. A mounting structure to which the ESLs and the product are attached can be designed as a shelf or a shelf level. It is also possible to attach them to a presentation table. Such ESLs can also be designed as display signs for placement on a table. Such an electronic display device can also be designed as a tag for attachment to clothing. The mounting structure can therefore also be designed as a connecting link between the electronic display device and the product. Such a mounting structure can therefore also be implemented, for example, as a fastening thread, needle, or similar. If larger packaging units of products are labeled by means of an ESL, the ESL can also be attached to the structure carrying the packaging units, such as a pallet, etc., or even to the packaging enclosing the plurality of products packed therein. Such autonomously operable ESLs usually comprise a battery for their power supply.

However, the ESLs can also be attached to a special electronic shelf rail designed to control and carry several ESLs, whereby such an electronic shelf rail uses an electronic shelf rail controller (often referred to simply as a controller) that supplies the ESLs attached to the electronic shelf rail with data and/or power. For this purpose, the electronic shelf rail comprises wires that can be connected to the ESL via contacts, which run along its length and are connected to the controller. In this configuration, these are not the autonomously operable ESLs described above, but rather externally powered ESLs with contacts, as they are powered via the controller, which in turn is powered by a battery or other means, as discussed below. Mechanically, the electronic shelf rail is designed to form the front edge of a shelf panel and is attached to the shelf panel either directly or via an adapter.

For the purpose of visualizing information, each display device comprises a screen, which is usually implemented as an electrophoretic screen in order to enable the most energy-efficient operation possible in battery-powered display devices that comprise a battery as an energy storage device. However, other types of screens, such as LCD screens, OLED screens, or similar, can also be used.

The electrical power supply can be provided by means of radio signals, known in technical jargon as “Power over WIFI,” whereby the energy transmitted in this way is stored in an electrical energy storage device, such as a rechargeable battery of the display device. The power supply can also be based on a photovoltaic panel, if not completely, then at least as a backup, which is used to supply power to the energy storage device of the electronic display device.

However, the electronic display device can also be designed as a so-called video shelf rail, which essentially comprises a relatively long video screen intended for mounting on the front edge of a shelf and adapted to the typical height of a conventional shelf rail, which is controlled by its own controller so that virtual ESLs can be displayed in addition to video content. Such video shelf rails are often supplied with power via a cable due to their power consumption.

Since these electronic display devices are installed essentially throughout the retailer's sales area, and in particular on shelves with several shelf panels, even on different levels one above the other, it has proven to be particularly advantageous to use an electronic device intended for displaying product and/or price information as the detection device, in particular an electronic display device for still image and/or video reproduction or a control device for controlling such an electronic display device, wherein the electronic device is designed for receiving the tag radio signal. This design essentially comprises at least one radio receiver that is technically suitable or designed for receiving the tag radio signal. This can be achieved by providing a separate (possibly additional) radio receiver or by sharing a radio receiver intended for other purposes, such as communication, which is usually part of a transceiver. The radio receiver is connected to a control device (a controller) of the electronic device in order to further process the fact of receiving the tag radio signal or its information content and/or make it accessible to or available for a higher-level system component. However, the radio receiver may also be integrated into the control device of the electronic device, i.e. form part of it.

Apart from the embodiments discussed in connection with the mentioned electronic display device, the electronic device designed for receiving the tag radio signal can also be implemented without a display function.

In view of the involvement of electronic display devices, it has also proven particularly advantageous that the automatic selection of the at least one detection device comprises shared use of a communication infrastructure provided by a retailer for the electronic display of product and/or price information. This measure avoids the otherwise necessary additional communication infrastructure for transmitting the aforementioned fact of receiving the tag radio signal and/or the information content transported thereby. The existing communication infrastructure is thus used as efficiently as possible in two ways, namely, on the one hand, for communication concerning the product and/or price information and, on the other hand, for transmitting the data concerning the reception of the tag radio signal. In addition, each of the electronic display devices can be addressed specifically, analogous to the addressing system used for the transmission of data relating to product and/or price information, in order to inform the relevant display device that it has been selected for receiving the tag radio signal.

This can be done, for example, by means of a first command (e.g. a reception start command) that is transmitted to the electronic display device and decoded there. In the display device, this causes its radio receiver, which is intended for receiving the tag radio signal, to be permanently ready to receive so that it can continuously receive the tag radio signal until a second command (e.g. a reception stop command) is received. This then causes the radio receiver to be deactivated, which reduces the power consumption at least by its share.

Optionally, it may also be provided that, after receiving the reception start command, the receive readiness of the radio receiver intended for receiving the tag radio signal follows a change cycle consisting of temporary receive readiness succeeded by a temporary lack of receive readiness of the electronic display device, which is intended to reduce energy consumption, until the second command (e.g. a reception stop command) is received.

As typical components of the communications infrastructure, a radio-based system for operating the display devices uses a plurality of access points that form a radio network for supplying the display devices with communications technology in order to send data addressed to the display devices or retrieve data (addressed) from the display devices.

Usually, a group of display devices is assigned to one access point respectively and can be addressed via this access point. The assignment works by selecting a suitable radio channel in the ISM radio band (ISM stands for “Industrial, Scientific and Medical”), which is used by the respective access point, and registering the relevant display device with the access point responsible for it. The display device memorizes the channel and the identity of the access point, and the access point memorizes the identity of the display device. The display device registered in this way can then communicate by radio with the access point specified in advance. If the connection to the predefined access point is lost, the display device can search for another access point that is available via radio, scanning the available channels (or those known to the display device or preprogrammed), and, when an access point or its radio signal is detected (e.g. based on the SSID-SSID stands for “Service Set Identifier”), re-register with this access point.

Spatially adjacent access points, which are distributed throughout the premises of a retailer, warehouse, or production facility in such a way that they can detect all display devices located there, preferably use radio channels in the ISM band that do not overlap as far as possible so as not to interfere with each other.

A largely standardized radio communication protocol, such as ZigBee ® or Bluetooth ®, can be used for radio communication between the display devices and the respective access points responsible for them. A proprietary radio communication protocol, such as the one disclosed in WO 2015/124197 A1, can also be used.

The access points are typically connected by cable to a central control device, namely a higher-level data processing facility. The data processing facility can, for example, be a local server on which a software application (such as management software) is run to manage and control the electronic display devices. A cloud-based data processing facility can also be used for this purpose, which provides the aforementioned functionality for managing and controlling the display devices. With the help of the access points, the data processing facility supplies the individual display devices with the information assigned to them, which is visualized by means of the respective screen, and can also query and respond to the operating status or other status data of the display devices, such as the battery charge status.

The data processing facility also has access to a digital map, which is set out either as a planogram or as a realogram or, in other words, forms a digital representation of the positions of the electronic display devices. This means that the data processing facility knows all the positions of the display devices in the area it manages. It is therefore able to select the favorable position based on its knowledge of the device position, i.e. to determine the favorably positioned detection devices.

The device, which exists separately, i.e. detached, from the radio tag, is at least temporarily moved along with the radio tag, which is equivalent to the determination that it is at least temporarily located in the vicinity or immediate surroundings of the radio tag.

It has proven particularly advantageous if at least one of the devices listed in the following group is used as the device (9) in the method, namely:
a personal digital assistant, abbreviated as PDA. Such a PDA is used, for example, by employees of the retailer as they move through the area to fulfill customer purchase orders, for which the term “store picking” is often used. Such a PDA can, for example, use its radio transmitter to send out a localization radio signal or use a light-emitting diode or its screen to send out a localization light signal, which can be used to automatically locate it in the area.
a smartphone. Such a smartphone is used, for example, by a customer of the retailer as they move through the area to display a shopping list or navigate the area. The smartphone can also transmit at least one of the localization signals discussed in connection with the PDA (localization radio signal or localization light signal) in order to be locatable.
a smart shopping cart. Such a smart shopping cart is used, for example, by a customer or an employee of the retailer as they move through the area to transport products, display price and/or product information about a product using a screen on the shopping cart, display a shopping list using the screen, or visualize additional information, such as navigation or advertising information, using the screen. The shopping cart can also transmit at least one of the localization signals discussed in connection with the PDA in order to be locatable.
a load transport vehicle. Compared to the smart shopping cart, such a load transport vehicle is designed to transport a larger quantity of products or goods and/or to transport heavier products or goods or generally higher loads. This can be, for example, a forklift truck or a self-propelled transport sled or the like. This load transport vehicle is mainly moved by an employee during their work in the area to bring products to the shelves, etc., and to replenish shelves. The transport vehicle can also transmit at least one of the localization signals discussed in connection with the PDA in order to be locatable.
a radio beacon transmitter, in particular a Bluetooth Low Energy radio beacon. This is the most basic design for the device. Such a device can be miniaturized and battery-operated, making it easy to transport, and its functionality can be reduced to simply emitting the localization radio signal.

Since retailers often already have an existing localization infrastructure, such as for handling store picking-related activities or for navigation support for customers or employees, it has proven particularly advantageous, according to a first variant for determining a position favorable for receiving the tag radio signal, that a localization infrastructure provided at a retailer for localizing a person moving within the business premises or the device moved with the person is used for the automatic determination of the device position. Similar to the discussions regarding the detection device, the advantage here is that an existing localization infrastructure is simply shared, but with the particular advantage that de facto no adjustment of the technical components involved is necessary. Rather, the data processing facility can directly access the determined device position and use it to select the appropriate detection device(s).

The process of automatically determining the device position can be carried out on a radio basis in accordance with a first embodiment. For this purpose, the localization radio signals are received by location receivers and evaluated in accordance with the technology used. FThus, a combination of at least three receivers can be used with the aid of a generally known triangulation method to narrow down or determine the device position. This can be implemented well, for example, in the case of WiFi or WLAN radio technology or Bluetooth technology, in particular by means of Bluetooth Low Energy Beacons, for example. However, it is preferable that each of the location receivers used is designed to independently determine the relative position of the device in relation to the receiver. The underlying design of the location receiver may comprise several receiving antennas. The electronics of the location receiver process the individual reception of the localization radio signals with each of the antennas in such a way that runtime differences and/or phase differences between the individual antennas are evaluated together with the respective measured reception signal strength in order to determine the distance to the device and the direction to the device. The measured reception signal strength is usually specified by means of the “Received Signal Strength Indicator,” which is recorded as standard in modern reception electronics. An example of this is the localization or real-time tracking system from “Quuppa Oy”, Keilaranta 1, 02150 Espoo, Finland, website: quuppa. com, abbreviated as QUUPPA. The real-time tracking system from “Quuppa Oy” mentioned above comprises a “locator” as a location receiver, for example the “Q17” or “Q35” models, and at least one “tag” for emitting the localization radio signal, whereby for example the “QT-1”, “QT3-1” or “QT1 modules” can be used. Depending on the distance between the “locator” and the “tag” to be taken into account, the combination of the “locator” “Q17” with one of the “tags” “QT-1,” “QT3-1,” or “QT1 Module” or of the “locator” “Q35” with one of the “tags” “QT-1,” “QT3-1,” or “QT1 Module” can be used.

Furthermore, the process of automatically determining the device position can be image-based. For this purpose, cameras can be installed at different locations in the area to capture the respective scene. Image capture is performed in the usual way using optoelectronic technology. Both still images and video recordings can serve as a basis for further processing. The recordings are analyzed using image or video analysis software, whereby objects that are known to the analyzing computer because they are preprogrammed or stored in advance, or their characteristics and/or the light signals they emit, are identified. As soon as such a search has been successful, the device position for the device in question is determined, taking various aspects into account. These aspects may relate to the known position of the camera in the area or room, its known orientation in the area or room, or its known optical imaging system. However, these aspects may also relate to additional objects contained in the image or video that are known to the analyzing computer as such or in terms of their characteristic properties and serve as a reference point for localization in the area or room. Cameras mounted in or on the shelves and/or surveillance cameras distributed throughout the area or room, etc., can be integrated for this purpose. With the appropriate hardware and programming, the analyzing computer can be located in the camera itself and contribute significantly to determining the device position. With knowledge of the aspects mentioned, which can be used to narrow down the device position, this can even be done entirely in the camera, and the camera delivers the device position (possibly together with an identifier that identifies the device, which is also recorded) to the data processing facility. If the camera is only designed to capture and transmit the recordings, the device position is determined as discussed directly at the data processing facility taking the aforementioned aspects into account.

According to a second variant for determining a position favorable for receiving the tag radio signal, a different approach can also be taken. According to this second variant, the device position is determined solely by the fact that a localization radio signal emitted by at least one of the detection devices is received. The localization radio signal has the characteristics of a radio beacon signal, which comprises data content that can be used to identify the emitting detection device because the connection between the detection device and the data content characterizing it is stored in the data processing facility or is accessible to it. For this purpose, the detection device is equipped with a radio module (e.g. designed to emit a Bluetooth Low Energy Beacon signal). This localization radio signal is emitted with a transmission power such that it can only be received in the vicinity, namely a reception range of a few meters to approximately twenty meters around the detection device, so that as soon as the localization radio signal is reliably received by the device, the device position can only be within this reception range. The fact that the device receives such a localization radio signal is therefore sufficient to conclude that the device is located within the reception range around the detection device identifiable by the data content. This is equivalent to fulfilling the first criterion for the detection device emitting the relevant localization radio signal. The device used for the purposes discussed here comprises a receiver module that is at least suitable for receiving the location radio signal. A transceiver (in particular a Bluetooth Low Energy transceiver) is preferably used for this purpose, which also allows the fact that the localization radio signal has been received, together with the data content, to be transmitted by radio to the data processing facility, where further processing, in particular the automatic selection of the detection device with the most favorable position for receiving the tag radio signal, is carried out. For the sake of completeness, it should also be mentioned here that several localization radio signals originating from different detection devices can be received at a device position, so that there may also be several detection devices with a favorable position.

It has also proven to be particularly advantageous if the method comprises an emission of a tag radio signal individual to the radio tag by the radio tag during its movement, in particular by a group of radio tags during their joint movement. This allows each radio tag to be detected during its movement and thus also tracked along its movement path. In particular, the emission of the tag radio signal during a joint, group movement of the radio tags ensures that none of the radio tags move unnoticed. This means that all radio tags moving as a group remain continuously detectable.

Furthermore, it has proven to be extremely expedient that the detection comprises receiving the tag radio signal by the at least one selected detection device and identifying the radio tag and/or a product associated with the radio tag based on the received tag radio signal. This measure not only allows the detection of the fact that a radio tag is present in the reception range of the at least one detection device, but also ensures that its identity is known and, consequently, that the movement path of the tag can be clearly detected. The same applies mutatis mutandis to the product to which the radio tag is attached.

It has proven particularly advantageous that the automatic selection is performed by the data processing facility, wherein the data processing facility digitally stores the positions of the detection devices or has access to the digitally stored positions. As discussed in connection with the first variant, the data processing facility also knows the device position. Based on this, the data processing facility selects the at least one detection device that is favorably positioned by the fact that a distance between the respective detection device and the device is smaller than a limit value. This means that the selection of the at least one detection device can be carried out entirely on a software basis, provided that the digital map of the area with the detection devices marked therein is available to the software and the device position in the area has been determined at least approximately, as discussed above, and is therefore available to the software. The digital map will comprise at least two, but preferably three dimensions. The two-dimensional map describes the area in terms of surface area, whereas the three-dimensional map also indicates the height above the plane, as is the case with a planogram or realogram, in which all ESLs or similar display devices are recorded in three dimensions.

According to the second variant, the automatic selection is also performed by the data processing facility. However, in this variant, the data processing facility is informed by means of the device about the at least one detection device to be selected. This is done by transmitting the data content of the localization radio signal received by the device, which was emitted by the detection device and received by the device. As already mentioned, the emitting detection device can be identified by means of the data content because the connection between the detection device and the data content characterizing it is stored in the data processing facility or is accessible to it. Viewed in general terms, in this variant it is therefore not even necessary for absolute positions, namely the absolute position of the device and/or the absolute position of the detection device, to be known to the data processing facility, because the automatic selection is based solely on the fact that there is such a close local relationship between the device and the relevant detection device that the device can reliably receive the localization radio signal from the detection device. In other words, the limit value mentioned in connection with the first variant naturally results for the second variant due to the transmission power predetermined in the detection device for emitting the localization radio signal and the associated radio signal propagation. The absolute device position therefore does not need to be explicitly determined. However, it is incidental at least limited to the reception area around the relevant detection device due to the fact that the data processing facility knows the position of the detection device in a preferred embodiment.

Due to the topological properties of an area, which is formed, for example, by a retailer's sales room, whereby the sales room is structured with all its aisles, display tables, and shopping baskets, etc., it has proven to be particularly advantageous if a distance of ten meters or less, preferably in the range of eight to four meters, particularly preferably less than four meters, is used as the limit value. This allows only a small group of detection devices, e.g. realized by the ESLs designed for receiving the tag radio signal, to be selected in the vicinity of the device position in an excellent way.

Optionally, it may also be provided that the data processing facility defines the limit value variably depending on the device position. Thus, for example, if the device position is determined to be within a spacious area in a store, i.e. outside the usually quite narrow aisles, a larger limit value can be set for the area than is the case for the aisles. On the one hand, this ensures that even when the device is located in the spacious area, at least a single or a small group of detection devices is selected so that the radio tags located there can be reliably detected. In this case, the limit value can certainly be set to 10 meters. At the same time, this also ensures that when radio tags are present within a shelf aisle, not too many, i.e. unnecessarily many, detection devices are selected at the same time, which would lead to unnecessarily increased energy consumption in the group of selected detection devices, which would not improve the detection result. In this case, if there are many detection devices in a relatively narrow area of the sales room, such as a narrow shelf aisle, the limit value can also be set to less than four meters. A direction-dependent limit value can also be set around the device position, which allows for very flexible modeling in order to take the real surrounding circumstances into account.

Since the data processing facility is aware of the structure and/or topology of the area, it can specify the limit value depending on the location in order to make an optimal number of detection devices selectable. This can be, for example, 1, 2, 3, or 4, or up to a maximum of 10 or 20 detection devices, so that the energy consumption for the detection process remains manageable and the selection is spatially limited to those detection devices that are presumed to be in the vicinity of the radio tags to be detected.

It has proven to be particularly advantageous if, in the case that several detection devices fulfil the first criterion, only a single one of these detection devices fulfilling the first criterion is selected sequentially for a predefined time period each for receiving the tag radio signal. This ensures that the total energy consumption of the group of selected detection devices is further optimized, i.e. minimized, because for each detection device that is active for receiving the tag radio signal, all other devices in the group do not comprise readiness to receive the tag radio signal, i.e. they are deactivated in this regard. For example, at the beginning of the group selection, the time schedule that all detection devices in the group must follow can be specified by command, i.e. programmed, in order to avoid generating increased communication effort, which would also require energy. On the other hand, switching between the detection devices, especially if they are designed as ESLs and are subject to a cycle of activity and inactivity in accordance with their basic communication behavior, can also be carried out by means of individual communication when the active state is present.

According to a further optional embodiment, it may also be provided that the data processing facility has access to the charge status of a battery of the at least one detection device selected or to be selected, because this charge status has been stored in advance or retrieved in real time and the time period during which only a single one of these detection devices that fulfil the first criterion is selected for receiving the tag radio signal is defined as inversely proportional to a charge status of a battery of the respective detection device. This ensures that the individual detection devices in the group of selected detection devices are involved for a period of time that is adapted to their individual charge status.

However, if the battery of those detection devices that already comprise an unfavorable charge status right from the start is to be spared, in the case that several detection devices fulfil the first criterion, it may be applied as a second criterion for automatic selection that, for the detection devices fulfilling the first criterion, knowing the charge status of a battery of these detection devices, those detection devices whose batteries exceed a charge status threshold value are selected for receiving the tag radio signal, in particular only that detection device whose battery comprises the highest charge status is selected for receiving the tag radio signal.

A subgroup of the detection devices favored in terms of position can thus be formed depending on the charge status, which extends the battery life of the other detection devices that already comprise a relatively low charge status and would have to be selected based on the first criterion.

With regard to the power supply of the radio tag, it may be provided that the radio tag is equipped with its own battery and operated electrically self-sufficiently in order to emit the tag radio signal. Thus, each radio tag equipped in this way can also be operated as a self-sufficient radio tag in an area where no external power supply is provided. As long as the battery comprises a sufficient charge, the radio tag can transmit its tag radio signal. As soon as the battery has too little charge for operation, the battery of the radio tag in question must be recharged or replaced. In this context, reference should be made, by way of example, to a product from “Wiliot Ltd.”, HaTochen 8, Ofek 10 Building, 3rd Floor, Caesarea 3079861, Israel, which is marketed under the name “Battery-Assisted IoT Pixels.”

It has proven particularly advantageous if the radio tag is powered electrically by an energy transfer radio signal in order to emit the tag radio signal. This enables the use of such radio tags without the time restrictions that would apply in the case of battery-operated radio tags for the method according to the invention. Such externally powered radio tags can therefore be used without interruption in the method discussed and thus ensure that they are continuously available for detection. In this context, reference should also be made, by way of example, to a product from the company “Wiliot Ltd.”, HaTochen 8, Ofek 10 Building, 3rd Floor, Caesarea 3079861, Israel, which is marketed under the name “Battery-Free IoT Pixels”.

For the purpose of external power supply, it has proven particularly advantageous if the energy transfer radio signal for electrical supply is emitted in a frequency range between 700 MHz and 1 GHz and/or in a frequency range above 2 GHZ.

The use of the frequency range between 700 MHz and 1 GHz ensures that the energy transfer radio signal can propagate as far as possible and is thus available for external power supply over a large area.

However, if the use of the technology typically referred to as 2.4 GHz or 5 GHz radio infrastructure in the area is to be further intensified, it has proven particularly advantageous for the energy transfer radio signal for electrical supply to be emitted in a frequency range of an ISM frequency band above 1 GHz, in particular the 2.4 GHz or 5 GHz ISM frequency band.

An additional radio infrastructure for the sole purpose of energy transfer can be dispensed with here, and the existing radio communication infrastructure and the radio signals generated in the process are used as the energy transfer radio signal.

In this context, reference is made to the so-called ISM bands, where ISM stands for Industrial, Scientific, and Medical, and the use of these frequency bands for industrial, scientific, and medical applications is license-free.

However, it may also be provided that a mixed configuration of low-frequency energy transfer radio signals in the 700 MHz and 1 GHz frequency range and high-frequency energy transfer radio signals in the 2.4 GHz or 5 GHz ISM frequency band is used in order, for example, to ensure the availability of at least one of the energy transfer radio signals in all areas of the premises. This mixed configuration can be advantageous if the radio tag is designed to operate selectively in two frequency bands, i.e. to receive the energy transfer radio signal in these two frequency bands and use it for its own electrical supply. In this context, reference is made by way of example to another product from the company “Wiliot Ltd. ,” HaTochen 8, Ofek 10 Building, 3rd Floor, Caesarea 3079861, Israel, which is marketed under the name “Dual Band IoT Pixel 117.”

If several energy transfer transmitting devices positioned at different locations are used in a larger area to emit the energy transfer radio signal, it has proven extremely advantageous that at least one, preferably exactly a single one, of the energy transfer transmitting devices is automatically selected which has the smallest distance to the device in comparison to at least one other energy transfer transmitting device. This measure also makes an important contribution to the energy-saving operation of the overall system, because only the selected energy transfer transmitting device or devices are activated to transmit the energy transfer radio signal. From the totality of the available energy transfer transmitting devices, a selection is therefore always made with regard to a single device position, which comprises one or more energy transfer transmitting devices, but less than the totality.

If selections have to be made with regard to several device positions, this can lead to overlaps in the selection sets for the energy transfer transmitting devices. In this case, it may be provided that an energy transfer transmitting device selected twice or multiple times remains selected until it is no longer relevant for any of the device positions to be taken into account.

To implement this measure, the data processing facility also knows the positions of the energy transfer transmitting devices in the area and can use the device position, which is also available to it, to decide which of the energy transfer transmitting devices is favored in terms of its position. In particular, the one that comprises the smallest distance to the device position is selected, as the radio tags to be detected are located in its vicinity.

The positions of the energy transfer transmitting devices can be stored in a separate data structure or integrated into the data structures used to store the planogram or realogram. In any case, the data processing facility has access to them.

The selection made by the data processing facility is then communicated to the relevant energy transfer transmitting device. This can be done via a wired connection, e.g. via a local area network (LAN) or via “Power over LAN,” so that the activation or deactivation of the relevant energy transfer transmitting device and its electrical power supply can be carried out via a wired connection using the same line. The energy transfer transmitting devices can also be integrated into a radio network. Their power supply can then be provided either by a battery or by a pure power supply.

They can also be supplied by radio signals, which can be implemented using the technology known as “Power over WiFi.”

In summary, the method discussed ensures the most efficient and energy-saving operation of the system discussed, because only those detection devices that are actually favored for detecting a tag radio signal are activated, and, at the same time, only those energy transfer transmitting devices are active for emitting the energy transfer radio signal that can actually be used for the radio-based external power supply of the radio tags in question. A detection infrastructure is established that dynamically adapts to the movement of the radio tag and in many cases efficiently shares an existing infrastructure. The position and movement of the radio tag are derived from the device position or equated with this device position or the change in device position in good approximation. Localization is therefore based on knowledge of the device's location and can be extremely advantageous for detecting individual radio tags or groups of radio tags associated with it.

The association of the device, and thus ultimately, at least indirectly, a position, with one or more of the radio tags can be done initially, i.e. before individual or possibly group-wise tracking or monitoring of the movement is started. This is used, for example, when a transport sled or forklift, etc., is loaded with a multitude of products that are to be tracked subsequently. The device can be integrated into the vehicle or be a PDA, smartphone, etc. belonging to the person operating the vehicle.

However, the association of the device with one or more radio tags can also be event-related, i.e. while the device is moving through the area.

This is used, for example, when a customer or employee picks up a product or an item to which a radio tag is attached. The relevant radio tag is then carried by the person, e.g. by hand, or placed in a shopping cart, transport sled, forklift, etc., and moved along with it. The device can be the smart shopping cart itself, or it can be integrated into the transport sled or forklift, etc., or it can be the person's PDA (Personal Digital Assistant), smartphone, etc.

The association process can be carried out, for example, in such a way that the device independently detects the respective radio tag (initially/on an event-related basis) once by receiving the tag radio signal, thus assuming the role of a mobile detection device on a one-time basis, and transmits the data received from the radio tag together with its identifier to the data processing facility, where the relationship between the device and the radio tag in question is stored. This process is particularly suitable when no other technical device is available apart from the device itself, because the association process is carried out at any location within the area, such as at any shelf where a customer removes a product to which the relevant radio tag is attached.

However, if the association process is carried out at a defined location, such as in a loading zone or in the area of a gate, a separate, permanently installed association device may be present there, which records both the mobile device and the radio tags moving with the mobile device once and transmits the identifier of the mobile device together with the data received from the radio tags to the data processing facility, where the relationship between the device and the relevant radio tag or radio tags is stored.

Ultimately, the relationship between the mobile device and the respective radio tag is stored in the data processing facility, so that subsequently only the device position during movement through the area needs to be determined in order to then carry out the detection of the associated radio tag with the at least one adjacent stationary detection device. This allows the location of the radio tag and its movement path to be tracked as long as it moves with the device.

Furthermore, the stocks of goods or changes therein can be easily detected along the movement path of the device.

An increase in the stocks of goods moved with the device can be detected or determined by the fact that a radio tag, which is attached to an item of goods, is newly associated with the device on an event-related basis and can therefore be detected in association with the device by means of the selected detection devices. This event-related association can be triggered manually on the device, for example, by the person carrying the device interacting with the user interface of a software application designed for this purpose that is running on the device. Event-related association can also be performed automatically, for example, when a smart shopping cart or the like is used. The shopping cart, for example, can recognize (using image recognition or a motion sensor, etc.) that a product is being placed in its basket and, triggered by this event, capture the radio tags in its basket once in order to determine the newly added item and make it available for further tracking of the radio tags that are being moved. This system allows, for example, the precise tracking of goods transported by customers or staff in their shopping carts without the need to access or collect personal data.

These measures also make it quite easy to check whether all goods being transported with a device have actually been paid for as soon as they move toward the exit of the area (e.g. the exit of the supermarket).

Furthermore, a reduction in the stocks of goods moved with the device can be determined by the fact that a radio tag associated with the device suddenly simply cannot be detected in correspondence with the movement path of the device, because the goods to which the radio tag is attached have already been deposited at their destination or elsewhere and can therefore no longer be detected in a very short time due to the changing selection of detection devices in accordance with the movement of the device. If this situation is detected, the association between the device and the radio tag in question can be dissolved. This allows, for example, the activity of restocking shelves by supermarket staff to be tracked automatically and verified that the goods identified by the respective radio tag have been placed in the correct location or at least in the correct area of the premises.

However, the radio tags moved with the device, as well as the reduction or increase in the number of radio tags moved, can also be detected by means of the freely movable device itself. For this purpose, the transport device, such as the smart shopping cart, the transport sled, or the forklift, etc., with which the device is moved either directly or indirectly by the person operating the transport device, comprises an energy transfer transmission device itself which serves for an in particular permanent radio-based energy supply to the radio tags located on board the transport device. The power supply already provided for the transport device is also used to supply power to the energy transfer transmitting device. This existing power supply is used in the transport device, for example, to operate the electronics or the electrified drive mechanism provided there. As long as the radio tags are supplied with power, they emit their individual tag radio signals, by means of which (i.e. via their data content) they can be clearly identified. The mobile device is configured as a detection device that continuously detects the tag radio signals and thus always knows the inventory of radio tags being moved, which allows the data processing facility to infer the products being moved with the device. This allows the device to always keep the products being moved with it, as well as their number, up to date, e.g. in a list. However, the list can also be maintained by the data processing facility, where it is managed, i.e. kept up to date, for the device.

If the increase in the stocks of goods moved with the device and the decrease in the stocks of goods moved with the device are continuously detected automatically as discussed, the data processing facility always maintains an overview of the stocks of goods actually moved with the device, and ultimately with the person moving the device. With this knowledge, the data processing facility can also create and ultimately optimize the route in the area for the person concerned. On the one hand, this measure can benefit the personnel responsible for restocking goods, because a more efficient and time-saving route is offered fully electronically (e.g. using the device in the form of a PDA). The same applies mutatis mutandis to staff (store pickers) who are busy collecting goods for customers who have placed their orders online, for example, and simply want to pick up their prepared purchases or have them delivered. However, this measure can also benefit customers in the store if the data processing facility has access to their electronic shopping list. Based on the shopping list, the route for the customer can be optimized and, by means of the detection device, it can be checked which goods the customer already has with them and which goods still need to be collected.

It is precisely the traceability of the radio tags along the device's movement path in a temporal context, which can be achieved, for example, by the data processing facility logging the route and time stamps, that opens up the possibility of the data processing facility selecting the detection devices that are to be classified in the future as being favorable in terms of their position prospectively (in anticipation) and controlling them in a timely manner for receiving the tag radio signal in order to establish readiness to receive the tag radio signal at the appropriate time or to ensure readiness to receive the tag radio signal within the appropriate time window. For this purpose, the relevant time or time window can be precalculated by the data processing facility on the basis of the temporal course of the device's previous movement path and transmitted, for example, by means of a reception start command to the detection devices to be activated in the future, whereby the selection is made by extrapolating the previous movement path and applying the first criterion. This measure can be of considerable benefit, in particular, if no ad hoc communication protocol is available for communication with the detection devices. This may be the case, in particular, if an existing communication infrastructure of an ESL system is drawn upon to utilize the relevant components designed for receiving the tag radio signal (ESL, controller, etc.) as detection devices. In such an ESL system, due to the large number of components involved and the communication protocol used, there are often considerable delays before the detection device to be selected can even be reached by means of communication technology. The automatic selection that is prospective in terms of location and time solves this inherent problem of such an ESL system and ensures timely availability at the most likely future location for reception of the tag radio signal.

It should also be mentioned that tracking radio tags that move with the device can be performed even without associating the device with a radio tag. It should be noted here that when the radio tags are detected by means of the detection device, those radio tags that are in a stationary position, as planned, at the respective location or in the vicinity of the relevant detection device are of course also detected, because they are located there, e.g. on the shelf in their designated place. However, since the data processing facility is informed of this planned position by accessing the planogram or the realogram, it can blank out the radio tags that are also detected as planned at the respective location or in the vicinity of the location defined by the device position, so that, as a result, only the radio tags that are actually moving with the device are tracked.

It should also be mentioned that the method is not limited to the detection of at least one moving radio tag. Rather, the method can also be used for the detection of one or more unmoved radio tags.

It should also be noted that the measures according to the invention also conserve the capacity of the available radio channels, because only the detection devices positioned favorably and/or the energy transfer transmitting devices positioned favorably are activated and transmit.

Finally, it should be mentioned in general that the electronic devices discussed (ESLs, access points, servers, etc.) or their stages or modules naturally comprise electronics. The electronics can be discrete or integrated, or a combination of both. Microcomputers, microcontrollers, application-specific integrated circuits (ASICs), possibly in combination with analog electronics or digital electronic peripheral components, may also be used. Many of the aforementioned functionalities of the devices are implemented, possibly in conjunction with hardware components, with the aid of software that is executed on a processor of the electronics. Devices designed for radio communication usually comprise an antenna configuration as part of a transceiver module, possibly also a matching network, etc., for transmitting and receiving radio signals, and can be controlled by digital signals or emit digital signals. Apart from the ESLs, the electronic devices may also comprise an internal electrical power supply, which can be implemented, for example, with a replaceable or rechargeable battery. The devices can also be supplied via a cable, either through an external power supply unit or by means of “Power over LAN.”

These and other aspects of the invention are illustrated in the figures discussed below.

### BRIEF DESCRIPTION OF THE FIGURES

The invention is explained in more detail below with reference to the accompanying figures using examples of embodiments, to which the invention is not limited, however. Identical reference signs are assigned to the same components in the various figures. The figures show schematically as follows:

FIG. 1 a system for carrying out the method according to the invention;

FIG. 2 an application scenario for the invention in retail;

FIG. 3 a detection device designed as a controller for an electronic shelf rail;

FIG. 4 an exemplary process sequence for detecting a radio tag by means of the detection device illustrated by means of a flowchart.

### DESCRIPTION OF THE EMBODIMENTS

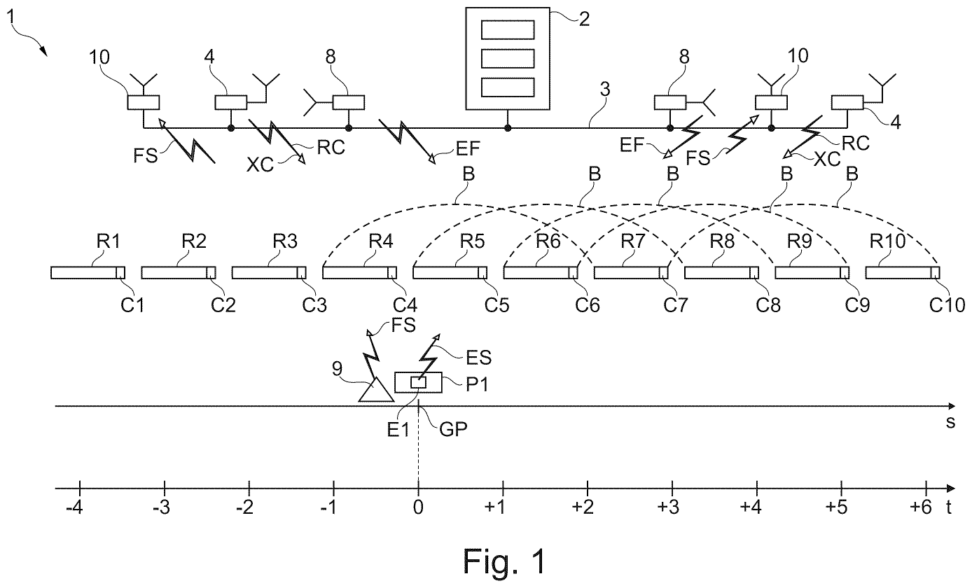

FIG. 1 shows a first embodiment of a system 1 designed to carry out the method according to the invention. The system 1 comprises a server 2 as a data processing facility. The server 2 is connected to a wired network implemented as a “local area network,” or LAN 3 for short.

Access points 4 are connected to the LAN 3. These access points are distributed throughout a shopping area of a supermarket and serve to connect electronic shelf rails R1 to R10 to the server 2 via radio technology. In the present case, it is assumed that the left access point 4 serves shelf rails R1 to R5, whereas the right access point 4 serves shelf rails R6 to R10. The electronic shelf rails R1 to R11, which are designed to communicate with the access points 4, can accommodate electronic displays, which are not shown for reasons of clarity and are referred to in technical jargon as “electronic shelf labels,” or ESLs for short. They are used to display product and/or price information relating to a particular item of goods. They are usually attached to the front edge of the shelf panel by means of the electronic shelf rails R1 to R10, essentially corresponding to the position of the goods presented on the shelf panel. These ESLs are supplied with power and communication technology externally by means of the electronic shelf rails R1 to R10. The shelf panels and the goods placed on them are also not shown in FIG. 1 for the reasons mentioned above. However, the arrangement of the electronic shelf rails R1 to R10 shows that the shelf panels are arranged next to each other along a movement path S.

The server 2 has access to the absolute positions of the electronic shelf rails R1 to R10 in the shopping area, whereby in the present case these positions are obtained from a digital planogram in which the respective absolute position of the electronic shelf rails R1 to R10 is stored digitally.

The electronic shelf rails R1 to R10 each comprise a controller C1 to C10 (also referred to as a control device in the general description) provided on their side, which is designed to communicate by radio with the access points 4 and, on the one hand, controls radio communication with one of the access points 4 and, on the other hand, communicates the instructions and/or display content received from the server 2 to the relevant ESL attached to its shelf rail R1 to R10 via a wired connection. The mechanics and electronics, or rather their software-based functionality, are disclosed in the published patent applications PCT/EP2021/055914 and PCT/EP2021/055916, but with the difference that the controller C1-C10, as referred to therein as the “supply device”, comprises a modification in the embodiment shown here.

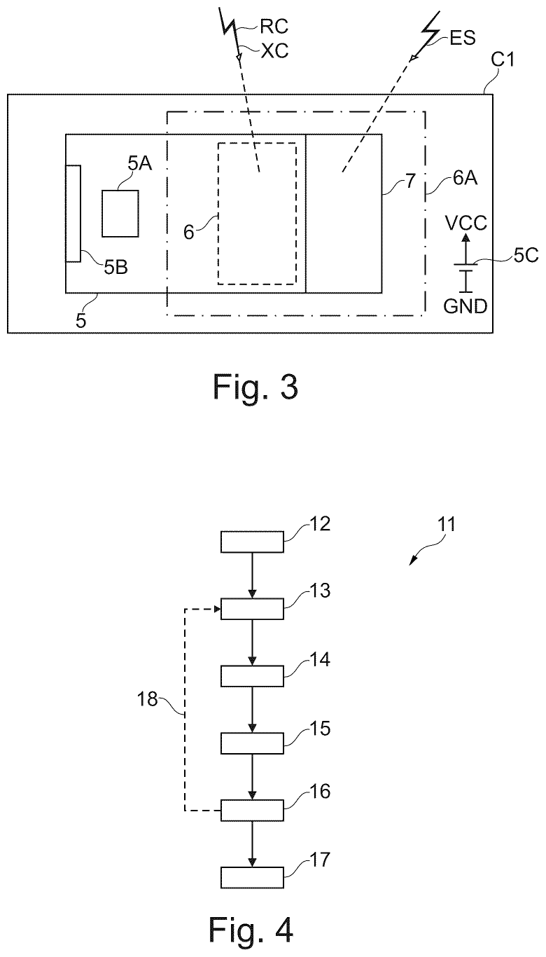

This modification is discussed in FIG. 3, where the controller C1 provided on the electronic shelf rail R1 is visualized in the form of a block diagram as a representative of all the others C2 to C9, and only the blocks relevant in the present context are visualized.

FIG. 3 shows general electronics 5 of the controller C1, which are discussed in detail in patent application PCT/EP2021/055916, and an access point radio module 6, also disclosed therein, for radio communication with one of the access points 4. To perform control tasks related to communication with ESLs connected to the electronic shelf rail R1 of the controller C1 or related to other radio-based reception and transmission tasks, the electronics 5 comprise a computer 5A (e.g. a microcontroller) on which software programmed for the tasks to be completed is executed. An interface 5B implemented with electrically conductive contact elements serves to contact lines of the electrical shelf rail R1 that run along its longitudinal extension in order to supply ESLs that also contact these lines with electrical power and to communicate with them via a wired connection. Furthermore, the controller C1 comprises a battery 5C for its electrical supply, whereby the battery 5C can also be designed separately from the controller C1, i.e. it can just be connected to it.

According to the modification, the controller C1 comprises a radio receiver module 7 that is designed for receiving a tag radio signal ES. At this point, it should also be mentioned that the radio receiver module 7 can be integrated into the access point radio module 6 or can be formed by the access point radio module 6, specifically by its receiver, which is indicated in FIG. 3 by the dash-dotted block 6A. The radio reception module 7 can be activated on an event-related basis by the server 2 by means of a reception start command RC via radio communication via the access points 4 with the controller C1 when it is needed for reception of the tag radio signal ES. Thus, each of the electronic shelf rails R1 to R10, or more precisely each of their controllers C1 to C10, forms a detection device for receiving the tag radio signal ES emitted by a radio tag E1.

The tag radio signal ES is transmitted by the radio tag E1 shown in FIG. 1, which is attached to a product P1 in order to identify the product P1 by means of its tag radio signal ES. The radio tag E1 must be supplied with energy for this purpose because it does not comprise a battery but is designed to obtain the energy required for its operation from a received radio signal. For this purpose, the system 1 comprises supply transmitters 8 distributed throughout the shopping area, which are designed to emit an energy transfer radio signal EF in the frequency range of approximately 900 MHz. The radio tag E1 is designed to use the energy transfer radio signal EF for “energy harvesting” for its own electrical supply. It is therefore externally powered by the energy transfer radio signal.

In the present case, it is assumed that the radio tag E1 is formed by a “Battery-Free IoT Pixel” from Wiliot Ltd, as already mentioned in the general description.

Furthermore, FIG. 1 shows a mobile battery-operated device 9, which is formed here by a portable radio beacon transmitter that emits an individual radio beacon signal FS, preferably a Bluetooth Low Energy beacon signal, for the purpose of identification and location. This radio beacon signal FS is received and evaluated by location receivers 10 distributed throughout the shopping area, and the result of determining the location of the device 9 is transmitted to the server 2. For this purpose, the localization or real-time tracking system marketed by QUUPPA can be used, for example, which comprises both the location receiver 10 and the device 9 as a radio beacon transmitter and enables highly precise localization of the device 9 with just a single location receiver 10 receiving the radio beacon signal FS. The server 2, or more precisely the software running on the server 2, which knows the position of the location receivers 10 in the shopping area, can thus convert the location of the device 9 determined in relation to the location receivers 10 into an absolute device position in the shopping area.

With regard to the device 9, it is assumed that the same is positioned close to the radio tag E1. Together, the radio tag E1 and the device 9 move along the path S past the electronic shelf rails R1 to R10, as indicated in FIG. 1. Both are located at different locations at different times, which is illustrated by a timeline t with a general time scale from −4 to +6 time units. At time t=0, both are located exactly in front of the fifth electronic shelf rail R5 and immediately adjacent to the fourth shelf rail R4 and the sixth shelf rail R6. This location is defined as the device position GP at time t=0. Prior to this, at time t=−3, for example, they were located directly opposite the second shelf rail R2, and in the future, at time t=+3, for example, they will be located directly opposite the eighth shelf rail R8, etc., whereby in the present case, by way of example, it is assumed that they are moving at a constant speed. In real use, however, the speed may vary.

Based on the infrastructure discussed above, a method according to the invention is now explained in the following, which is visualized in FIG. 4 by means of a flowchart 11. This method is essentially provided with the aid of the software executed on the server 2 and draws on data obtained from the infrastructure.

The method 11 starts in block 12.

In block 13, the location of the device 9 in the shopping area is determined, whereby the relative position of the device 9 determined by means of the location receiver 10 and related to the location receiver 10 is communicated to the server 2, where it is converted into the absolute device position GP in the shopping area, knowing the absolute position of the location receiver 10 in the shopping area.

In block 14, those controllers C1 to C10 are searched for in relation to the device position GP which fulfill a first criterion, namely that they are located within a proximity limit B, in the present case, by way of example, less than five meters, away from the device position, as indicated accordingly in FIG. 1. Since the software knows the absolute positions of controllers C1 to C10 in the shopping area, it calculates the distance between the device position GP and the position of the respective controllers C1 to C10 and selects the controllers C4 to C6, since only these controllers C4 to C6 fulfill the first criterion.

In block 15, the aforementioned reception start command RC is then sent to the controllers C4 to C6 in order to activate their radio reception module 7 for receiving the tag radio signal ES.

In block 16, the tag radio signal received by means of the controllers C4 to C6 is communicated by the controllers C4 to C6 to the server 2 via one of the access points 4, where it is further processed by the software. This involves evaluating the information content of the tag radio signal ES in order to identify the radio tag E1, on the one hand, and the product P1 logically linked to the radio tag E1, on the other, whereby this logical link is also accessible to the software, e.g. by accessing its own database or by obtaining it from another database, in order to consequently know the current location of the product P1 in the shopping area.

If only the current position of the radio tag is of interest, the method can end in block 17.

However, if the sequence of positions, i.e. the movement in the shopping area, is of interest, the method is continued in a loop 18 via blocks 13 to 16 until the software terminates the method.

If, in the course of the movement at time t=1, the flowchart 11 discussed above is run through again, then at this point in time the controllers C5 to C7 are selected for receiving the tag radio signal, because only they now fulfill the first criterion, which is visualized by the shift of the proximity limit B to the right. During the movement of the device 9, the group of the selected controllers C4 to C6, C5 to C7, C6 to C8, C7 to C9, and C8 to C10 changes step by step, which is indicated by the further stepwise shift of the proximity limit B to the right. The controllers that are no longer selected are instructed to deactivate their reception module 7, after it was active, by means of the reception stop command XC mentioned in the general description. This leads to an activated detection infrastructure that changes locally within the shopping area according to the movement dynamics of the device 9. In other words, or figuratively speaking, “the group of detection devices selected to detect the tag radio signal, which comprises a smaller number of members than the total number of detection devices, wanders along with the device 9.” This is therefore a “logical” “wandering along,” i.e. one related to the selection, and not a mechanical “wandering along.”

The system of detection devices activated in accordance with the first criterion depending on the location can also be applied to the selection of the supply transmitters 8. For example, the software of the server 2 can keep the left supply transmitter 8 activated while the right one is deactivated when the device 9 is located adjacent to the controllers C1 to C5, and keep the left supply transmitter 8 deactivated while the right supply transmitter 8 is activated when the device 9 is located adjacent to the controllers C6 to C10. This leads to a more efficient power supply of the radio tag E1 by means of the respective energy transfer radio signal EF.

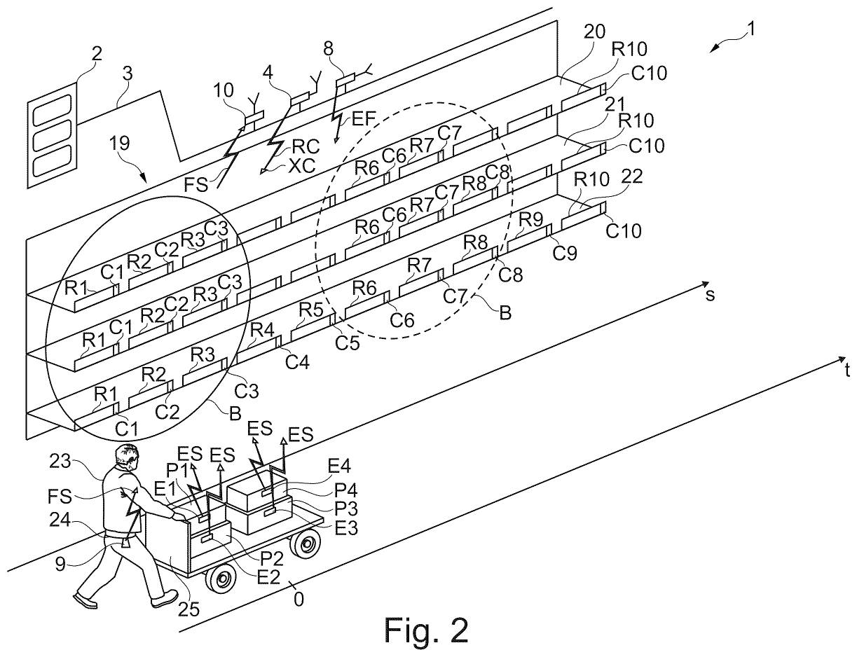

Subsequently, by means of FIG. 2, the invention is visualized once again on the basis of a spatial view along a shelf 19. In the present case, in particular in contrast to FIG. 1, the entities 4, 8, and 10 are shown only once for reasons of clarity, which does not, however, preclude the fact that they may be or are present multiple times in a real implementation in a retailer's store. The shelf 19 comprises three levels 20, 22, and 21. Each level 20-21 is equipped with ten electronic shelf rails R1 to R10, whose controllers C1 to C10 can be addressed individually for each level by the server 2 or its software. Each shelf 20-21 therefore comprises the configuration of electronic shelf rails R1 to 10 with their controllers C1 to C10 shown in FIG. 1, whereby these infrastructure elements are only provided with reference signs throughout on the lowest level, and only three of these infrastructure elements are designated per level on the two levels above in order not to overload the figure. For reasons of simplified illustration, only one further group of infrastructure elements 4, 8, and 10 is shown.

Furthermore, FIG. 2 shows a person 23 carrying the device 9, realized as a radio beacon transmitter, on a belt 24 while moving along the path S. The person is pushing a load transport vehicle 25 loaded with the products P1 to P4. The products P1 to P4 are labeled with the radio tags E1 to E4, whereby they are distinguished by a characteristic data content of their tag radio signal ES.

In the present case, in accordance with the preceding discussions, the device position of the device 9 is determined within the proximity limit B (less than 5 meters) adjacent to the electronic shelf labels R1 to R3 of the three levels 20-21. In order to make a more energy-efficient selection, the software compares the charge statuses, those that are available to it, of the batteries (not shown) of the electronic shelf rails R1 to R3 located within the proximity limit B and selects, for example, only the controller C1 of the lowest level and the controller C3 of the top level as detection devices for receiving the tag radio signals ES.

This process, which now also takes into account the charge status of the battery of the respective electronic shelf rails R1 to R10, is repeated over time. For example, at a determined device position in the proximity range B of the electronic shelf rails R6 to R8, only a single detection device (e.g. the controller C6 of the middle level) is selected for receiving the tag radio signal ES. Its battery comprises the highest charge status compared to the other controllers C6 to C8 that can be selected within the proximity limit B. This enables the most energy-efficient use possible, especially in an environment with densely packed detection devices.

If autonomous ESLs are used as detection devices, their block diagram structure differs from that of the controller C1 in that interface 5B is missing and a screen is provided instead. In addition to radio-based reception and transmission tasks, computer 5A controls the screen to display the price and/or product information received by radio.

A second embodiment of the system 1 will be discussed below, which focuses on the second variant according to the general description. In this system 1, the location receivers 10 distributed and fixedly located in the business premises (=shopping area) according to FIGS. 1 and 2 can basically be dispensed with in order to discuss the processes in the system 1, but this does not exclude the possibility that the location receivers 10 may still be provided for other purposes. The same applies mutatis mutandis to the supply transmitters 8 distributed and fixedly located in the business premises.

Furthermore, the following framework conditions apply.

A mobile phone, by way of example, is used as freely movable (mobile) battery-operated device 9. This device comprises a Bluetooth Low Energy transceiver (first “BTLE transceiver”) so that the tag radio signals ES can be received. The device 9 is assigned to a person 23, which is also known to the server 2 because this connection is stored there in a data structure or can be obtained from an external data source. The person 23 is a supermarket employee who is busy restocking the products P1-P4. The products P1-P4 are located on the load transport vehicle 25. The load transport vehicle 25 comprises an electric drive that is powered electrically by a powerful drive battery. In the present case, the load transport vehicle 25 comprises the supply transmitter 8, which, as a part of the load transport vehicle 25, is therefore also moved with the load transport vehicle 25 and is also supplied with electricity by means of the drive battery. The transmission power of the supply transmitter 8 is set so that the radio tags E1-E4 attached to the products P12-P4 are reliably supplied with energy by the energy transfer radio signal EF on the load transport vehicle 25, but this energy transfer radio signal EF has as small a range as possible beyond the load transport vehicle. As long as the radio tags E1-E4 are within the energy supply range of the energy transfer radio signal EF, they emit their respective tag radio signal ES, which is received by the device 9 by means of the first BTLE transceiver. The device 9 thus monitors the existence of the radio tags E1-E4 on the load transport vehicle 25 either continuously or at intervals (e.g. periodically). In order to compensate for the power consumption caused by this in the device 9, it may be provided that the device 9 is connected to the electronic supply of the load transport vehicle 25, i.e. it draws its electrical power from the drive battery. Inductive charging may also be provided for this purpose.

The device 9 thus generates a list of the identifiers of the radio tags E1-E4, hereinafter referred to as the list of tag identifiers, from the data content of the respective tag radio signal ES. This list is automatically adapted or changed when one of the radio tags E1-E4 is removed from the load transport vehicle 25 or when the load transport vehicle 25 is loaded with a product that carries its own radio tag. By comparing with the server 2, which knows the relationship between the identifier of the respective radio tag E1-E4 with the products P1 to P4 or can establish this relationship with the help of an external data source, the device 9 can always provide the person 23 with plain text information about the products and/or store a list of the (unique) product identifications for those products that are currently on the load transport vehicle 25. The inclusion of an external data source may also be necessary because the label identifiers are subject to encryption, in particular one that changes over time, the system of which is only known to the external data source.

The electronic shelf rails R1-R10 used, specifically their controllers C1-C10, are modified in the present case in such a way that, in contrast to the modification according to FIG. 3, they comprise a combined Bluetooth Low Energy receiver and transmitter module 7 (second “BTLE transceiver”) instead of the receiver module 7 discussed there. This allows at least two different operating modes to be implemented.

In a first operating mode, the module 7 acts as a Bluetooth Low Energy beacon and emits a Bluetooth Low Energy beacon signal (hereinafter referred to as the controller beacon signal), which can be received by the transceiver of the device 9 as soon as the device 9 is within the transmission range of the module 7. In order to obtain good spatial resolution, the transmission range within which the controller beacon signal can be reliably received can be limited to a few meters, e.g. less than 20 meters or less than 10 or even less than 5 meters, by adjusting the transmission power.

In a second operating mode, the module 7 is in reception mode to receive various messages via Bluetooth Low Energy radio communication.

The first message may be a message from the device 9 containing the list of product identifications that identify products that need to be restocked in relation to a specific shelf rail.

The second message may be a message from a radio tag E1-E4 containing the specific label identifier.

The significance of these messages will be discussed below in connection with an explanation of the operation of the system 1.

First, the person 23 activates a software application on their device 9 that has been programmed and installed for the purpose of restocking products. The server 2 electronically provides information on the device 9 regarding the products P1 to P4 to be restocked, and the person 23 loads the load transport vehicle 25 with the products P1 to P4. The radio tags E1-E4 attached to the products P1-P4 are supplied with power there via radio, emit their tag radio signals, and the device 9 detects the label identifiers transmitted with them, so that either the device 9 itself or, after communication with the server 2, the correct selection of the products P1 P4 is confirmed and a list of the products located on the load transport vehicle 25 is generated.

Once the loading process is complete and as soon as the person and the load transport vehicle 25 start moving to restock the products P1-P4, this circumstance is communicated to the server 2 by radio (e.g. by means of WLAN or by means of IoT communication, such as in accordance with the 5G or 6G mobile communications standard or higher) from the device 9, whereupon the server 2 activates the first operating mode of the module 7 in those controllers C1-C10 that are assigned to the products P1-P4 located on the load transport vehicle 25. In the present case, with reference to the shelf 19 according to FIG. 2, it is assumed that the controller C1 of the lowest level 22 is assigned to the products P1 and P2, the controller C7 of the middle level 21 is assigned to the product P3, and the controller C10 of the top level 20 is assigned to the product P4.

The device 9 now moves with the person 23 along the path S shown in FIG. 2 close enough to the controller C1 of the lowest level 22 so that the controller beacon signal emitted from there can be received. As soon as this reception takes place, the device 9 instructs the relevant controller C1 via communication with the server 2 to activate the second operating mode. The module 7 then enters into the reception state, which corresponds to the automatic selection of the relevant controller C1 for receiving a tag radio signal(ES) emitted by the radio tag (E1-E4) and/or an identifier derived therefrom, namely a product identification that can be derived from the tag identifier by means of the server 2 or an external data source available to the server.

Depending on how close the products P1-P4 on the load transport vehicle 25 have been brought to the relevant controller C1, the first message or the second message can now be received by the controller 1.

If the products P1 to P4 with the radio tags E1 to E4 attached to them have been brought close enough to the relevant controller C1, the controller can directly receive the tag radio signals ES from the radio tags E1 to E4, i.e. receive the second message, and also receive the first message.

The relevant controller C1 is provided with the product identification of the two products P1 and P2 by means of the first message. Depending on the application, this can be interpreted as meaning that individual products are being restocked in terms of type and/or quantity. In the present case, the transmission of two product identifications can mean that two different product types are each restocked with one item or that two items of one product type are restocked. The controller C1 therefore always has a direct overview of the number of products actually restocked and can communicate this information to the server 2, where the inventory on the shelf and in the warehouse is monitored. By receiving the two messages, which is communicated to the server 2 by the controller C1, it is possible for the server 2 to determine that both the products P1 and P2, or rather their packages to which the radio tags E1 and E2 are attached, and the person 23, who is responsible for carrying out the restocking process, are/were in the immediate vicinity of the relevant shelf position where the products P1 and P2 are to be placed. From this, it is automatically concluded that the restocking process for the two products P1 and P2 has been completed.

Subsequently, the server 2 instructs the relevant controller C1 to enter its energy-saving mode, in which the module 7 is deactivated in order to save energy.

However, if the products P1 to P4 are so far away from the relevant controller C1 that it cannot directly receive the tag radio signals ES, only the first message is received by the relevant controller C1. This is also communicated by the affected controller C1 to the server 2. In this case, it can at least be determined by the server 2 that the person 23, who is responsible for restocking, was near the affected shelf space for which the products P1 and P2 are intended. This information also leads to the automatic conclusion that the restocking process for the two products P1 and P2 has at least been completed with a high degree of probability. The server 2 then instructs the relevant controller C1 to enter its energy-saving mode, in which the module 7 is deactivated in order to save energy.

For the two scenarios discussed in the two preceding paragraphs, it can be concluded in any case for the server 2 that the restocking process for the two products P1 and P2 has been successfully completed if, subsequently, the radio tags E1 and E2 assigned to the products P1 and P2 are detected by the device 9 as missing on the load transport vehicle 25, because their tag radio signals ES are no longer received by the device 9 as the load transport vehicle 25 continues to move along the path S.

Subsequently, the described process is repeated for the two remaining products P3 and P4 in an analogous manner, but at different locations along the path S.

The invention therefore allows the restocking process for products to be tracked completely electronically in a manner that is as energy-efficient and radio channel-friendly as possible.

Finally, it should be noted once again that the figures described in detail above are only examples of embodiments which can be modified in various ways by a person skilled in the art without departing from the scope of the invention. For the sake of completeness, it should also be noted that the use of the indefinite articles “a” or “an” does not exclude the possibility that the features in question may also be present multiple times.

1. Method for detecting a radio tag (E1-E4), in particular one that is variable in location, by means of detection devices (C1-C10) positioned at different locations, wherein the method comprises the following method steps:
automatically selecting a number of detection devices (C1-C10) that is smaller than the total number of detection devices (C1-C10) for receiving a tag radio signal(ES) emitted by the radio tag (E1-E4) and/or a product identification derived from the tag radio signal(ES), wherein as a first criterion for automatic selection it is applied that, in relation to an in particular automatically determined device position of a device (9) located at least temporarily in the vicinity of the radio tag (E1-E4), at least one of the detection devices (C1-C10) is positioned favorably with respect to at least one other detection device (C1-C10) for receiving the tag radio signal(ES) and/or the product identification.

2. Method according to claim 1, wherein the method comprises an emission of a tag radio signal(ES) individual to the radio tag (E1-E4) by the radio tag (E1-E4) during its movement, in particular by a group of radio tags (E1-E4) during their joint movement.

3. Method according to claim 1, wherein the automatic determination of a device position is radio-based.

4. Method according to claim 1, wherein the automatic determination of the device position is image-based.

5. Method according to claim 1, wherein the device position is determined solely by the fact that a localization radio signal emitted by at least one of the detection devices is received.

6. Method according to claim 1, wherein the detection comprises:
receiving the tag radio signal (ES) by the at least one selected detection device (C1-C10), and
identifying the radio tag (E1-E4) and/or a product associated with the radio tag (E1-E4) based on the received tag radio signal (ES).

7. Method according to claim 1, wherein
the automatic selection is performed by a data processing facility (2), wherein
the data processing facility (2) digitally stores the positions of the detection devices (C1-C10) or has access to the digitally stored positions and knows the device position, and wherein
the data processing facility (2) selects the at least one detection device (C1-C10) that is favorably positioned by the fact that a distance between the respective detection device (C1-C10) and the device (9) is smaller than a limit value, or wherein
the automatic selection is performed by a data processing facility (2) which is informed by means of the device (9) about the at least one detection device (C1-C10) to be selected.

8. Method according to claim 7, wherein a distance of ten meters or less, preferably in the range of four to eight meters, particularly preferably less than four meters, is used as the limit value.

9. Method according to claim 7, wherein the data processing facility (2) defines the limit value variably depending on the device position.

10. Method according to claim 1, wherein, in the case that several detection devices (C1-C10) fulfill the first criterion, only a single one of these detection devices (C1-C10) fulfilling the first criterion is selected sequentially for a predefined time period each for receiving the tag radio signal(ES).

11. Method according to claim 10, wherein the time period is defined as inversely proportional to a charge status of a battery (5C) of the respective detection device (C1-C10).

12. Method according to claim 1, wherein, in the case that several detection devices (C1-C10) fulfill the first criterion, it is applied as a second criterion for automatic selection that, for the detection devices (C1-C10) fulfilling the first criterion, knowing the charge status of a battery (5C) of these detection devices (C1-C10), those detection devices (C1-C10) whose batteries (5C) exceed a charge status threshold value are selected for receiving the tag radio signal (ES), in particular only that detection device (C1-C10) whose battery (5C) comprises the highest charge status is selected for receiving the tag radio signal (ES).

13. Method according to claim 1, wherein the radio tag (E1-E4) is operated electrically self-sufficiently in order to emit the tag radio signal (ES).

14. Method according to claim 1, wherein the radio tag (E1-E4) is powered electrically by an energy transfer radio signal in order to emit the tag radio signal (ES).

15. Method according to claim 14, wherein the energy transfer radio signal (EF) for electrical supply is emitted in a frequency range between 700 MHz and 1 GHz and/or in a frequency range of an ISM frequency band above 1 GHz, in particular the 2.4 GHz or 5 GHz ISM frequency band.

16. Method according to claim 13, wherein several energy transfer transmitting devices (10) positioned at different locations are used to emit the energy transfer radio signal (EF), and at least one, preferably exactly a single one, of the energy transfer transmitting devices (10) is automatically selected which has the smallest distance to the device (9) in comparison to at least one other energy transfer transmitting device (10).

17. Method according to claim 1, wherein at least one of the devices listed in the following group is used as the device (9) in the method, namely:
a personal digital assistant, abbreviated as PDA;
a smartphone;
a smart shopping cart;
a load transport vehicle;
a radio beacon transmitter, in particular a Bluetooth Low Energy radio beacon.

18. Method according to claim 1, wherein an electronic device intended for displaying product and/or price information is used as the detection device (C1-C10), in particular an electronic display device for still image and/or video reproduction or a control device for controlling such an electronic display device, wherein the electronic device is designed for receiving the tag radio signal (ES).

19. Method according to claim 1, wherein the automatic selection of the at least one detection device (C1-C10) comprises shared use of a communication infrastructure (2, 3, 4) provided at a retailer for the electronic display of product and/or price information.

20. Method according to claim 1, wherein a localization infrastructure (2, 3, 8) provided at a retailer for localizing a person (23) moving within the business premises or the device (9) moved with the person (23) is used for the automatic determination of the device position.
